(19) United States
(12) Patent Application Publication
(10) Pub. No.: US 2024/0289446 A1
(43) Pub. Date: Aug. 29, 2024

(54) EXTRACTION METHOD, EXTRACTION DEVICE, AND EXTRACTION PROGRAM

(71) Applicant: NIPPON TELEGRAPH AND TELEPHONE CORPORATION, Tokyo (JP)

(72) Inventors: Daiki CHIBA, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 18/290,029

(22) PCT Filed: May 12, 2021
(86) PCT No.: PCT/JP2021/018127

§ 371 Date: Nov. 9, 2023

(51) Int. Cl. G06F 21/55

(52) U.S. Cl. CPC G06F 21/554; G06F 2221/034

(57) ABSTRACT

An extraction method executed by an extraction device includes acquiring an observation result by a predetermined organization with respect to an indicator of compromise (IOC) included in information on cyber security, and creating feature information of the IOC based on information obtained from the observation result acquired.

### TECHNICAL FIELD

The present invention relates to an extraction method, an extraction device, and an extraction program.

### BACKGROUND ART

In order to ensure cybersecurity in companies and organizations, systems for security management and detection of threats have been introduced. A security operation center (SOC) is an organization for operating such a system. An analyst of the SOC monitors and analyzes a large amount of logs and alerts output from a system, and takes necessary measures.

On the other hand, according to the following Reference Literature 1 and Reference Literature 2, it is a problem that a situation called alert fatigue is caused for an analyst who processes a large amount of alerts occurring daily, leading to the exhaustion of the analyst.
Reference Literature 1: S. C. Sundaramurthy, A. G. Bardas, J. Case, X. Ou, M. Wesch, J. McHugh, and S. R. Rajagopalan, “A human capital model for mitigating security analyst burnout,” Proc. SOUPS, 2015.
Reference Literature 2: Ponemon Institute, “Improving the Effectiveness of the Security Operations Center,” 2019.

In order to solve the above problem, it is necessary to realize better automation and reduce an amount of operations for the analyst. In fact, according to Reference Literature 3, many SOC managers have recognized that the automation level of the SOC components being insufficient is the most important challenge in current SOC organizations.
Reference Literature 3: F. B. Kokulu, A. Soneji, T. Bao, Y. Shoshitaishvili, Z. Zhao, A. Doupe, and G.-J. Ahn, “Matched and Mismatched SOCs: A Qualitative Study on Security Operations Center Issues,” Proc. ACM CCS, 2019.

On the other hand, for example, a technique for discriminating between a truly malicious alert and an inherently non-malicious alert that is erroneously detected by estimating an abnormality score and a malignancy score of each alert related to security from past alerts has been proposed (see, for example, NPL 1 to NPL 5).

Also, a technique for supporting subsequent processes of an analyst by extracting information having the highest relevance to each alert related to security is known (see, for example NPL 6 to NPL 8).

### CITATION LIST

### Non Patent Literature

[NPL 1] W. U. Hassan, S. Guo, D. Li, Z. Chen, K. Jee, Z. Li, and A. Bates, “NoDoze: Combatting Threat Alert Fatigue with Automated Provenance Triage,” Proc. NDSS, 2019.
[NPL 2] A. Oprea, Z. Li, R. Norris, and K. Bowers, “MADE: Security Analytics for Enterprise Threat Detection,” Proc. ACSAC, 2018.
[NPL 3] K. A. Roundy, A. Tamersoy, M. Spertus, M. Hart, D. Kats, M. Dell'Amico, and R. Scott, “Smoke Detector: Cross-Product Intrusion Detection With Weak Indicators,” Proc. ACSAC, 2017.
[NPL 4] Y. Liu, M. Zhang, D. Li, K. Jee, Z. Li, Z. Wu, J. Rhee, and P. Mittal, “Towards a Timely Causality Analysis for Enterprise Security,” Proc. NDSS, 2018.
[NPL 5] P. Najafi, A. Muhle, W. Punter, F. Cheng, and C. Meinel, “MalRank: a measure of maliciousness in SIEM-based knowledge graphs,” Proc. ACSAC, 2019.
[NPL 6] C. Zhong, J. Yen, P. Liu, and R. F. Erbacher, “Automate Cybersecurity Data Triage by Leveraging Human Analysts' Cognitive Process,” Proc. IEEE IDS, 2016.
[NPL 7] C. Zhong, T. Lin, P. Liu, J. Yen, and K. Chen, “A cyber security data triage operation retrieval system,” Comput. Secur., vol. 76, pp. 12-31, 2018.
[NPL 8] S. T. Chen, Y. Han, D. H. Chau, C. Gates, M. Hart, and K. A. Roundy, “Predicting Cyber Threats with Virtual Security Products,” Proc. ACSAC, 2017.
[NPL 9] P. Vadrevu, B. Rahbarinia, R. Perdisci, K. Li, and M. Antonakakis, “Measuring and Detecting Malware Downloads in Live Network Traffic,” Proc. ESORICS, 2013.
[NPL 10] M. Antonakakis, R. Perdisci, D. Dagon, W. Lee, and N. Feamster, “Building a dynamic reputation system for DNS,” Proc. USENIX Security Symposium, 2010.
[NPL 11] L. Bilge, E. Kirda, C. Kruegel, and M. Balduzzi, “EXPOSURE: Finding Malicious Domains Using Passive DNS Analysis,” Proc. NDSS, 2011.
[NPL 12] R. Perdisci, I. Corona, and G. Giacinto, “Early Detection of Malicious Flux Networks via Large-Scale Passive DNS Traffic Analysis,” IEEE Trans. Dependable Secure Comput., vol. 9, No. 5, pp. 714-726, September 2012.
[NPL 13] S. Alrwais, X. Liao, X. Mi, P. Wang, X. Wang, F. Qian, R. Beyah, and D. McCoy, “Under the Shadow of Sunshine: Understanding and Detecting Bulletproof Hosting on Legitimate Service Provider Networks,” Proc. IEEE S&P, 2017.
[NPL 14] B. Rahbarinia, R. Perdisci, and M. Antonakakis, “Segugio: Efficient behavior-based tracking of malware-control domains in large ISP networks,” Proc. IEEE/IFIP DSN, 2015.

### SUMMARY OF INVENTION

### Technical Problem

However, the prior art has a problem that feature information useful for determining the priority of IOC investigation cannot be obtained.

For example, in the technique described in the prior art literature, feature information necessary for determining whether the IOC is abnormal or malignant is adopted. On the other hand, whether an IOC is abnormal or malignant is independent of whether the IOC requires a detailed investigation by an analyst.

### Solution to Problem

In order to solve the above-mentioned problem and to achieve the purpose, the extraction method is an extraction method executed by an extraction device, and includes an acquisition process of acquiring an observation result by a predetermined organization with respect to an indicator of compromise (IOC) included in information on cyber security, and a creation process of creating feature information of the IOC based on information obtained from the observation result acquired by the acquisition process.

### Advantageous Effects of Invention

According to the present invention, feature information useful for determining the priority of IOC investigation can be obtained.

### BRIEF DESCRIPTION OF DRAWINGS

FIG. 1 is a diagram illustrating a security system.

FIG. 2 is a diagram illustrating an example of an alert monitor screen.

FIG. 3 is a diagram illustrating an example of an IOC checker screen.

FIG. 4 is a diagram illustrating a configuration example of a determination device according to a first embodiment.

FIG. 5 is a diagram illustrating an example of a request period.

FIG. 6 is a flowchart illustrating a flow of learning processing.

FIG. 7 is a flowchart illustrating a flow of processing for extracting feature information.

FIG. 8 is a flowchart illustrating a flow of prediction processing.

FIG. 9 is a diagram illustrating an example of a computer that executes a determination program.

### DESCRIPTION OF EMBODIMENTS

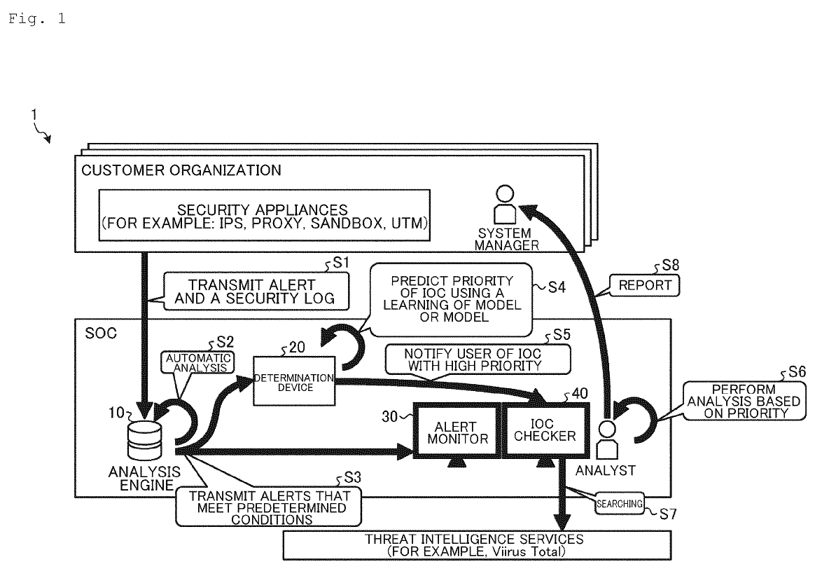

Hereinafter, embodiments of an extraction method, an extraction device, and an extraction program according to the present application will be described in detail with reference to the drawings. Note that, the present invention is not limited to the embodiments to be described below. In the present embodiment, the determination device functions as an extraction device.

[Configuration of First Embodiment] First, a security system including a determination device according to the first embodiment will be described with reference to FIG. 1. FIG. 1 is a diagram illustrating the security system.

The security system 1 performs automatic analysis by an analysis engine or analysis by an analyst based on predetermined information generated in a security appliance of the customer organization.

The security appliance is, for example, an intrusion protection system (IPS), a proxy, a sand box, a Unified Threat management (UTM), and the like.

In the SOC, information on security acquired from the security appliance is analyzed in real-time. For example, the information on security includes a security log and an alert.

In the example illustrated in FIG. 1, the SOC is used as an outsource SOC provided by a large-scale managed security service provider (MSSP). On the other hand, the present embodiment is also applicable to in-house SOC.

Although there is a systematic difference between the out-source SOC and the in-house SOC, the overall workflow is similar. Therefore, if the in-house SOC has a scale that can sufficiently exhibit scale merits, the effect of the present embodiment can be easily obtained.

The flow of processing in the security system 1 will be described. As illustrated in FIG. 1, first, the security appliance of the customer organization transmits an alert and a security log to an SOC analysis engine 10 (step S1).

An example of the case where processing is performed for an alert will be described below. The security system 1 can process the security log in the same manner as the alert.

The analysis engine 10 performs automatic analysis (step S2). The analysis engine 10 responds to an alert by performing analysis based on known malicious characteristics, a rule and a black list defined in advance.

The analysis engine 10 may perform the analysis using a function called Security Orchestration, Automation, and Response (SOAR).

The analysis engine 10 transmits an alert satisfying a predetermined condition to a determination device 20, an alert monitor 30, or an IOC checker 40 (step S3).

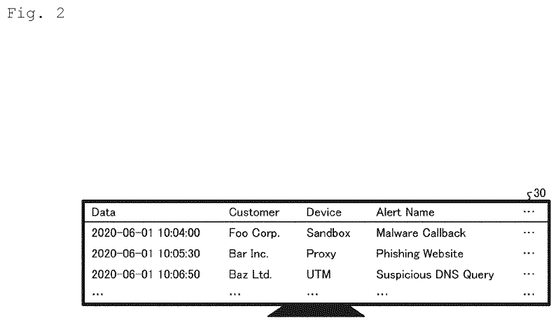

At this time, as illustrated in FIG. 2, the alert monitor 30 displays information on the alert. FIG. 2 is a diagram illustrating an example of an alert monitor screen.

For example, on the alert monitor 30, a date of an event causing an alert (Date), a customer name (Customer), a device transmitting the alert (Device), the name of the alert (Alert Name), the outline of a situation that becomes the trigger of the alert, and the like are displayed.

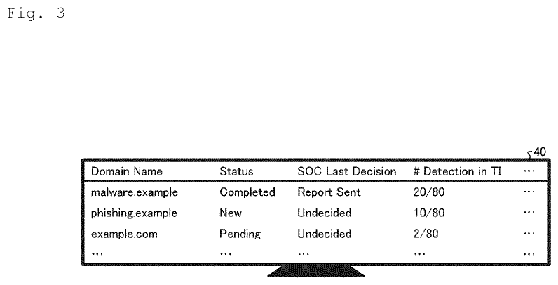

Further, as illustrated in FIG. 3, the IOC checker 40 displays information on the indicator of compromise (IOC) included in the alert. FIG. 3 is a diagram illustrating an example of an IOC checker screen.

For example, in the IOC, a domain name, an IP address, an URL, a file hash value or the like is included.

As illustrated in FIG. 3, for example, the IOC checker 40 displays the investigation status of the SOC (Status), the last decision of SOC regarding the degree of malignancy of the IOC (SOC Last Decision), the latest threat intelligence result of the IOC (Detection in TI), and the like.

For example, the analyst performs triage (evaluation) of the IOC for an alert that cannot be processed by the analysis engine 10 using a tool dedicated to the IOC evaluation, such as the alert monitor 30 and the IOC checker 40.

The analyst of the SOC processes a large amount of alerts in a daily SOC workflow. Therefore, the determination device 20 determines the IOC with the high priority and notifies the analyst of the IOC. Thus, it is possible to prevent a plurality of analyst from manually evaluating the same IOC in the SOC.

Further, according to the determination device 20, the IOC with the high priority can be analyzed preferentially, so that the effect on the operation amount of the analyst can be improved.

The determination device 20 learns the model or predicts the priority of the IOC using the model (step S4). Then, the determination device 20 determines the IOC with high priority based on the prediction result, and notifies the analyst of the determined IOC (step S5).

For example, the determination device 20 notifies the analyst of the determined IOC via the IOC checker 40.

The analyst executes analysis based on the notified priority (step S6). In addition, the analyst may search a threat intelligence service (for example, VirusTotal (https://www.virustotal.com/)) during the course of the analysis (step S7).

Some threat intelligence services provide scores on levels and malignancy of threats. However, such a score does not necessarily determine the next action of the analyst.

For example, the IOC associated with attacks utilizing vulnerability in which patches have already been deployed may have a high score of malignancy, but is not an imminent threat in view of protecting customer organization.

Since the alert analysis in the SOC is not simple, it is difficult to completely automate the alert analysis, and there is a case where an analyst needs to make a determination.

Therefore, the determination of the IOC with the high priority by the determination device 20 can be useful for securing the time required for the analyst to determine and reducing the investigation operation of each IOC.

The analyst finally determines whether the alert to be analyzed and the IOC included in the alert are malignant or non-malignant, further determines whether a report to the customer is necessary, and in a case where the report to the customer is necessary, reports to a system manager or the like of a customer organization (step S8).

For example, once the analyst completes the evaluation of an IOC, the triggered conditions of the alert in the analysis engine 10 can be changed based on the result.

For example, in a case where a malicious IOC is clearly specified by an analyst's evaluation, the IOC can be used in the analysis engine 10 as a custom blacklist or a custom signature.

In this case, the log including the same IOC can be automatically detected even by other customers having the SOC. Also, in a case where an IOC with a low level of false detection or threat is specified by evaluation, the SIEM logic triggering the alert is changed, and the same false detection alert can be prevented from being generated again, resulting in reduction of the operation of the analyst.

Hereinafter, the processing for determining the IOC with the high priority by the determination device 20 will be described in detail with the configuration of the determination device 20.

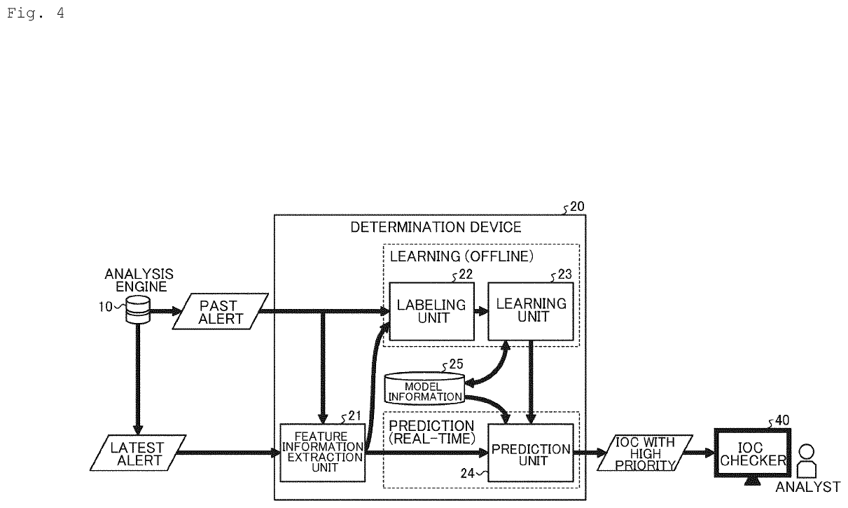

FIG. 4 is a diagram illustrating a configuration example of the determination device according to the first embodiment. As illustrated in FIG. 4, the determination device 20 includes a feature information extraction unit 21, a labeling unit 22, a learning unit 23, a prediction unit 24, and model information 25.

The determination device 20 performs learning processing of a model by a machine learning method and prediction processing using the learned model.

In the learning processing, the feature information extraction unit 21, the labeling unit 22, and the learning unit 23 are used. In addition, in the prediction processing, the feature information extraction unit 21 and the prediction unit 24 are used.

The feature information extraction unit 21 extracts feature information from the IOC included in the information related to cyber security. For example, the information on the cyber security is an alert acquired from the analysis engine 10.

The feature information extraction unit 21 extracts information characterizing characteristics of the IOC (hereinafter, feature information) from the IOC included in the past alert acquired from the analysis engine 10.

The feature information may be a domain name, an IP address, a URL, a file hash value or the like included in the IOC.

For example, the feature information extraction unit 21 extracts feature information from an alert generated during a predetermined fixed number of days.

Here, an extraction method of feature information by the feature information extraction unit 21 will be described in detail. The feature information extraction unit 21 functions as an extraction device having an acquisition unit and a creation unit.

The acquisition unit acquires an observation result by a predetermined organization with respect to an IOC included in information on cyber security. The creation unit creates the feature information of the IOC based on information obtained from the acquired observation result.

The feature information extraction unit 21 creates feature information based on observation results (items 1, 2, and 3) by the threat intelligence service or observation results (items 4 and 5) in a network such as the Internet.

Feature information of each item will be described. First, the feature information of Items 1, 2 and 3 is feature information which focuses on the characteristics of the threat already observed by the threat intelligence service in relation to each IOC.

The feature information extraction unit 21 acquires a detection status of an item related to the IOC by a threat intelligence service. The feature information extraction unit 21 creates feature information based on the detection status.

The threat intelligence service may be prepared by a customer organization or provided by an external organization. For example, the threat intelligence service is a service capable of acquiring threat information related to a domain name, an IP address, a URL, and a file hash value such as VirusTotal.

The number of feature information items included in Items 1, 2 and 3 is, for example, 28. Hereinafter, it is assumed that the feature information of the item represented as the item X and the item represented as the item X-Y is the feature information included in the item X.

### (Item 1)

The feature information extraction unit 21 refers to a threat intelligence service in a case where there is the IOC of a domain name, counts the number of four items of (1) a detection URL including the domain name, (2) a detection file communicated to the domain name, (3) a detection file downloaded from the domain name, and (4) a detection file referring to the domain name, respectively, and uses the number as feature information.

Thus, the feature information extraction unit 21 obtains, for example, four pieces of feature information. According to the feature information of Item 1, it is possible to identify whether the IOC is associated with a known threat.

Here, the detection URL including the domain name of (1) is defined as the URL detected by at least one or more of arbitrary detection engines on the threat intelligence service among URLs having common domain name portions.

In addition, the detection file communicated to the domain name of (2) is defined as the file detected by at least one or more of arbitrary detection engines on the threat intelligence service among files confirmed to communicate to the domain name through execution and analysis in a sand box environment.

In addition, the detection file downloaded from the domain name of (3) is defined as the file detected by at least one or more of arbitrary detection engines on the threat intelligence service among files acquired from the domain name.

In addition, the detection file referring to the domain name of (4) is defined as the file detected by at least one or more of arbitrary detection engines on the threat intelligence service among files including the character string of the domain name inside.

### (Item 2)

The feature information extraction unit 21 refers to a threat intelligence service in a case where there is an IOC of a domain name, and counts the number of four items of (1) a non-detection URL including the domain name, (2) a non-detection file communicated to the domain name, (3) a non-detection file downloaded from the domain name, and (4) the number of non-detection files referring to the domain name, respectively, and uses the number as feature information.

The feature information of Item 2 corresponds to the feature information obtained by replacing the portion “detected” of Item 1 with “not detected”. The URL or file that has not been detected means that the URL or file has been inspected by the threat intelligence service but has not been detected as a malicious or suspicious one by any detection engine.

Thus, the feature information extraction unit 21 obtains, for example, four pieces of feature information. According to the feature information of Item 2, it is possible to identify whether the IOC is benign or regular.

### (Item 3)

The feature information extraction unit 21 collects information on the number of detections that the number of detection engines among a plurality of detection engines present in the threat intelligence service has detected, for each of (1) to (4) of Item 1.

Further, the feature information extraction unit 21 calculates, for the four kinds of detection numbers, five statistics (an average value, a minimum value, a maximum value, a standard deviation, and dispersion) to create 20 pieces of feature information in total.

In this way, the feature information extraction unit 21 creates feature information based on information obtained from the observation result and statistics calculated from the information.

According to the feature information of Item 3, it is possible to distinguish whether the detected URL or file is a major threat detected by more detection engines or a minor threat detected only by a small number of detection engines.

The feature information of Items 4 and 5, which focuses on the characteristics of communication observed in the network associated with each IOC, will be described. The network is, for example, the Internet.

Specifically, the feature information extraction unit 21 uses a Passive domain name system (DNS) database to acquire information indicating how much each IOC is referred to in a certain network.

The Passive DNS database is a database in which correspondence relationship between domain names and IP addresses and history thereof are recorded from actually exchanged DNS messages by observing the communication in any cache DNS server or authority DNS server.

The Passive DNS database may be prepared by a customer organization or may be provided by an external organization.

The feature information extraction unit 21 extracts, as feature information on communication characteristics observed in a network, five items included in Items 4 and 5, and 147 pieces of feature information in total.

### (Item 4)

The feature information extraction unit 21 acquires a domain name system (DNS) record corresponding to a domain name associated with the IOC as an observation result, and creates, for example, 7 pieces of feature information based on the number of changes in the information of the DNS record.

For example, in a case where there is an IOC of a domain name, the feature information extraction unit 21 refers to a Passive DNS database, and counts the number of times of change of the resource record from a certain point of time in the past to the present is counted as feature information for each of the seven types of DNS resource records (A, AAAA, CNAME, MX, NS, SOA, TXT) corresponding to domain names.

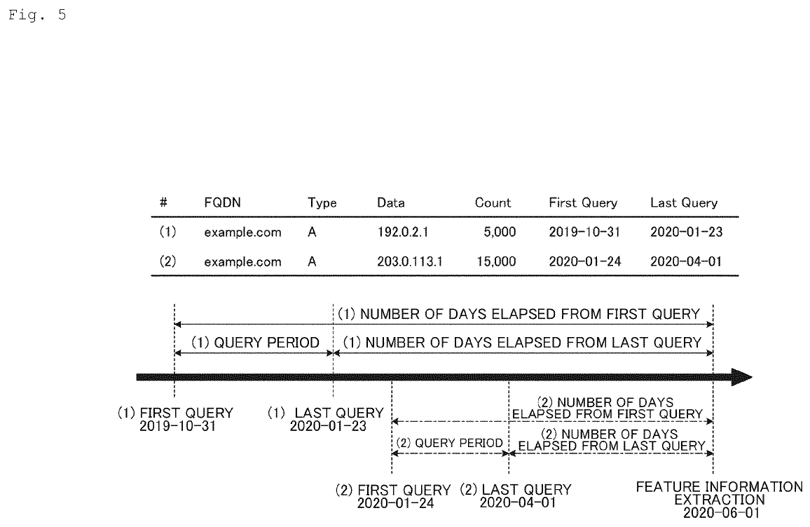

For example, in a case where it is observed that an A record (IPv4 address) of “example.com” has become “192.0.2.1” in the past and then “203.0.113.1” as illustrated in a table on the upper side of FIG. 5, the feature information extraction unit 21 counts the number of times of changing the IOC corresponding to the domain name “example.com” as 1.

According to the feature information of Item 4, a domain name in which the DNS record itself is frequently changed and a domain name in which the DNS record is stably used can be distinguished.

In the case of an IOC other than the domain name, the feature information extraction unit 21 may extract the above-mentioned feature information after associating the IOC with the domain name.

For example, in a case where the IOC is the URL “https://www.example.com,” the feature information extraction unit 21 counts the IOC is associated with the domain name portion “www.example.com”.

In addition, in a case where the IOC is an IP address, the feature information extraction unit 21 can extract the domain name associated with the IP address by obtaining the corresponding domain name, or using the Passive DNS database by referring to the reverse record of DNS.

Further, in a case where the IOC is a file hash value, the feature information extraction unit 21 can extract the destination of the communication of the file or the original domain name of the download of the file by referring to the threat intelligence service.

### (Item 5)

The feature information extraction unit 21 acquires a domain name system (DNS) record corresponding to a domain name associated with the IOC as an observation result, and creates, for example, 140 pieces of feature information based on the number of times of use and a use period of the DNS record.

### (Item 5-1)

The feature information extraction unit 21 creates, for example, 35 pieces of feature information based on the average value, minimum value, maximum value, standard deviation, and dispersion of past DNS query counts.

For example, in a case where an IOC of a domain name exists, the feature information extraction unit 21 first refers to the Passive DNS database as in Item 4, and counts the number of DNS queries for each combination among seven types of DNS resource records (A, AAAA, CNAME, MX, NS, SOA, TXT) corresponding to domain names.

Here, the number of DNS queries is defined in a Passive DNS database as the number of times of observation of a combination of resource records (for example, “example.com,” an A record, “192.0.2.1”).

On the upper side of FIG. 5, there are shown an example of two past DNS A records of “example.com” and the number of DNS queries thereof (5,000 times and 15,000 times, respectively).

Next, the feature information extraction unit 21 calculates, for the seven kinds of resource records, five statistics (an average value, a minimum value, a maximum value, a standard deviation, and dispersion) and creates 35 pieces of feature information in total.

According to the feature information of Item 5-1, the tendency of the number of Internet users accessing the domain name can be reflected.

### (Item 5-2)

The feature information extraction unit 21 creates, for example, 35 pieces of feature information based on the average value, minimum value, maximum value, standard deviation, and dispersion of the elapsed days from the first DNS query.

For example, in a case where an IOC of a domain name exists, the feature information extraction unit 21 first refers to the Passive DNS database as in Item 4, and extracts the date when the first DNS query for each combination was performed for each of the 7 types of DNS resource records (A, AAAA, CNAME, MX, NS, SOA, and TXT) corresponding to domain names.

Next, the feature information extraction unit 21 calculates the number of elapsed days from the date to the day of extracting feature information for each date.

FIG. 5 illustrates an example of two records for “example.com” and the date when the first DNS query was observed.

For example, as illustrated in FIG. 5, in a case where it is assumed that the feature information is extracted on Jun. 1, 2020, the feature information extraction unit 21 counts the number of days from 2019 Oct. 31 to 2020 Jun. 1 for the first record and the number of days from 2020 Jan. 24 to 2020 Jun. 1 for the second record.

According to the feature information of Item 5-2, the DNS trend related to the domain name can be reflected around the use start time of each record.

### (Item 5-3)

The feature information extraction unit 21 creates 35 pieces of feature information based on the average value, minimum value, maximum value, standard deviation, and deviation of the number of days elapsed since the last DNS query.

For example, in a case where the IOC of the domain name exists, the feature information extraction unit 21 changes the “first DNS query” of Item 5-2 to the “last DNS query” to extract feature information.

For example, as illustrated in FIG. 5, in a case where it is assumed that the feature information is extracted on Jun. 1, 2020, the feature information extraction unit 21 counts the number of days from 2020 Jan. 23 to 2020 Jun. 1 for the first record and from 2020 Apr. 1 to 2020 Jun. 1 for the second record.

Thereafter, the feature information extraction unit 21 calculates five statistics (an average value, a minimum value, a maximum value, a standard deviation, and dispersion) of the number of days counted for each of the seven types of resource records, and creates 35 pieces of feature information in total.

According to the feature information of Item 5-3, the DNS trend related to the domain name can be reflected by focusing on the time when the use of each record is stopped.

### (Item 5-4)

The feature information extraction unit 21 creates 35 pieces of feature information based on the average value, minimum value, maximum value, standard deviation, and dispersion during the period when DNS queries existed.

For example, in a case where there is an IOC of a domain name, the feature information extraction unit 21 extracts the date of the first DNS query for each of the 7 types of DNS resource records (A, AAAA, CNAME, MX, NS, SOA, TXT) corresponding to the domain name as in Item 5-2 to obtain the date of the last DNS query as in Item 5-3.

In the example illustrated in FIG. 5, the feature information extraction unit 21 counts the number of days from 2019 Oct. 31 to 2020 Jan. 23 for the first record and the number of days from 2020 Jan. 24 to 2020 Apr. 1 for the second record.

Thereafter, the feature information extraction unit 21 calculates five statistics (an average value, a minimum value, a maximum value, a standard deviation, and dispersion) of the number of days counted for each of 7 types of resource records, and creates 35 pieces of feature information in total.

According to the feature information of Item 5-4, the DNS trend related to the domain name can be reflected by focusing on how long each record is used.

The labeling unit 22 applies a label corresponding to an actual result of an operation amount required for corresponding to a related alert to each of the IOC.

Here, it is assumed that the label is binary data indicating whether or not the priority is high. For example, the labeling unit 22 applies a label indicating that priority is high to the IOC which has consumed much operation of the analyst in the past, and applies a label indicating that priority is not high to the IOC which has not consumed much operation of the analyst in the past.

In the prior art (for example, the techniques described in NPL 4 to NPL 8), the label indicating whether the IOC is malignant (or malicious) has been applied. On the other hand, in the present embodiment, a label is applied based on the operation amount of the analyst.

The labeling unit 22 applies a label indicating that priority is high to an IOC in which the number of times of manual investigation generated within a fixed period for a related alert is equal to or more than a predetermined value among IOC, and applies, to the IOC in which the number of times of manual investigation is less than the predetermined value, a label indicating that the priority is not high.

In the following description, the label indicating that the priority is high is referred to as “priority,” and the label indicating that the priority is not high is referred to as “non-priority”.

The learning unit 23 learns a model for outputting a label from the feature information of the IOC using learning data obtained by combining the feature information extracted by the feature information extraction unit 21 and the label applied by the labeling unit 22.

The learning unit 23 creates and updates a model by supervised machine learning. The model information 25 is information including parameters and the like for constructing a model. The learning unit 23 creates and updates the model information 25.

The learning unit 23 can adopt an algorithm of known arbitrary supervised machine learning. In the present embodiment, the learning unit 23 adopts a standard logistic regression.

The logistic regression is scalable and fast, and therefore is suitable for predicting the IOC included in a large amount of alerts from many customers, such as an SOC environment.

It is also known that logistic regression is highly interpretable. The output of the logistic regression can be interpreted as the probability that the input IOC is given priority due to its nature, and further, it can indicate which feature of the feature information corresponding to each IOC contributes to the result. Thus, logistic regression has the advantage of high interpretation possibility.

In this case, the learning unit 23 uses logistic regression with L1 regularization in particular.

First, when a vector x representing the feature information extracted by the feature information extraction unit 21 is given, the learning unit 23 models a conditional probability Y of the label shown in Equation (1) as shown in Equation (2).

$$\begin{matrix}[ Math . 1 ] & \\ y ∈ \{ 0 ( non - priority ) , 1 ( priority ) \} & ( 1 )\end{matrix}$$

$$\begin{matrix}[ Math . 2 ] & \\ p ( y = 1 \vert x ; θ ) = σ ( {θ}^{T} x ) = 1 / ( 1 + exp ( - {θ}^{T} x ) ) & ( 2 )\end{matrix}$$

Here, θ is a parameter of the logistic regression model. In addition, σ is a sigmoid function. In addition, it is also assumed that all the features of x are normalized to the range [0, 1].

The learning unit 23 uses a set of learning data with n labels shown in Equation (3) in order to obtain a parameter θ when minimizing an objective function of Equation (4) into which a Hyper parameter λ for determining a degree of regularization is introduced.

$$\begin{matrix}[ Math . 3 ] & \\ {\{ ( {x}_{i} , {y}_{i} ) \}}_{i = 1}^{n} & ( 3 )\end{matrix}$$

$$\begin{matrix}[ Math . 4 ] & \\ {min}_{θ} {\sum }_{i = 1}^{n} - log p ( {y}_{i} \vert {x}_{i} ; θ ) + λ {‖ θ ‖}_{1} & ( 4 )\end{matrix}$$

In Equation (4), a L1 regularized portion λ∥θ∥₁ adds a penalty to the objective function, and has an effect of identifying and reducing feature information that does not contribute significantly.

Such reduction of the feature amount contributes to prevention of overfitting that matches learning data more than necessary, and also has an effect of reducing memory usage and making it easier to interpret results presented on the SOC analyst.

The prediction unit 24 predicts a label from the feature information of the IOC using the model learned by the learning unit 23.

The prediction unit 24 inputs feature information corresponding to the IOC included in an alert newly generated in real time using the model learned by the learning unit 23, and predicts which IOC will consume much operation of the analyst in the future.

For example, the prediction unit 24 performs prediction using a logistic regression model constructed based on the model information 25.

For example, the prediction unit 24 predicts a probability that an analyst manually analyzes the target IOC K times or more within P days (where P is an integer).

The prediction unit 24 uses the parameter θ determined by the learning unit 23 to obtain a probability p that the vector x of the feature information corresponding to the IOC is “priority,” and defines a label \hat{ }y (\hat{ } directly above y) to be predicted by Equation (5).

$$\begin{matrix}[ Math . 5 ] & \\ \hat{y} = \{ \begin{matrix}1 , & if p ( y \vert x ; θ ) \geq 0.5 \\ 0 , & otherwise\end{matrix} & ( 5 )\end{matrix}$$

The determination device 20 outputs the IOC considered leading to repeated investigation by an analyst of SOC, that is, an IOC in which a “priority” label is predicted, in order of a higher probability p, based on the label predicted by the prediction unit 24, and presents the result to the analyst.

At this time, the analyst can prioritize the investigation object using the information presented by the determination device 20, and efficiently perform triage and detailed analysis.

The analyst of the SOC is required to determine and record what action should take for the IOC as much as possible.

According to the present embodiment, the analyst can examine the IOC with the high priority and reflect the result on the analysis engine 10. Thus, since the analysis engine 10 can automatically process an alert including the same IOC, an analyst can avoid manually investigating the IOC every time, and the operation amount of the whole SOC can be reduced.

For example, the analyst investigates the IOC determined to have high priority, and makes the analysis engine 10 automatically analyze the IOC based on the result. Thus, since the IOC is not delivered to other analyst, the operation amount is reduced.

The determination device 20 re-executes the learning process periodically (for example, once a day) off-line to update the model information 25. The determination device 20 performs learning processing using data in a predetermined period before and after the feature information extraction time illustrated in FIG. 5. For example, the determination device 20 performs learning processing using data of F+L days obtained by combining F days until the feature extraction time and L days from the feature information extraction time (where F and L are integers).

On the other hand, when the determination device 20 processes the IOC included in the alert from the customer organization in real-time, that is, when performing prediction processing, the feature information is extracted using data for the past F days.

Then, the determination device 20 calculates a probability p at which K times or more of manual investigation by the analyst is performed in future P days from the extracted feature information.

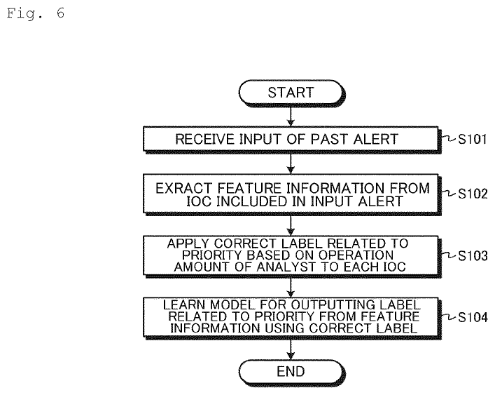

The determination device 20 repeats the prediction processing for each IOC receiving in real-time. As a result, the list of IOCs to be preferentially investigated by the analyst is displayed on the screen of the IOC checker 40 as illustrated in FIG. 3 and is continuously updated.

[Processing of First Embodiment] FIG. 6 is a flowchart illustrating the flow of learning processing. As illustrated in FIG. 6, first, the determination device 20 receives input of past alerts (step S101).

Next, the determination device 20 extracts feature information from the IOC included in the input alert (step S102). Then, the determination device 20 applies a correct label related to the priority based on the operation amount of the analyst to each IOC (step S103).

Then, the determination device 20 learns a model for outputting a label related to the priority from the feature information using the correct label (step S104).

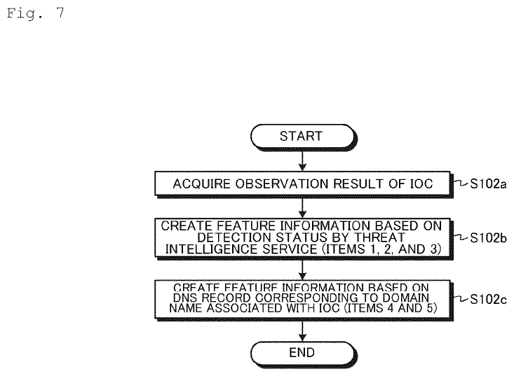

FIG. 7 is a flowchart illustrating a flow of processing for extracting the feature information. The processing illustrated in FIG. 7 corresponds to the processing of step S102 in FIG. 6.

First, as illustrated in FIG. 7, the determination device 20 acquires the observation result of the IOC (step S102a).

Next, the determination device 20 creates feature information based on a detection status by the threat intelligence service (Items 1, 2, and 3) (step S102b). Further, the determination device 20 creates feature information based on the DNS record corresponding to the domain name associated with the IOC (Items 4 and 5) (step S102c).

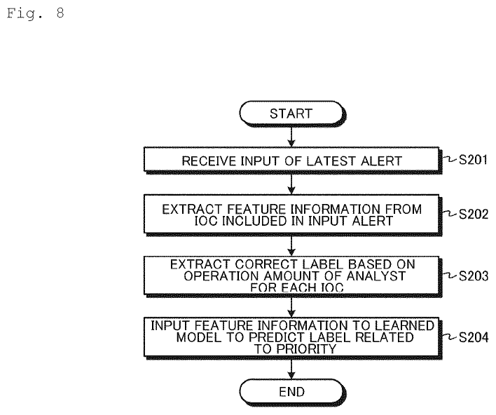

FIG. 8 is a flowchart illustrating the flow of prediction processing. As illustrated in FIG. 8, first, the determination device 20 receives the input of the latest alert (step S201).

Next, the determination device 20 extracts feature information from the IOC included in the input alert (step S202). Then, the determination device 20 extracts a correct label based on the operation amount of the analyst for each IOC (step S203).

Then, the determination device 20 inputs the feature information to the learned model, and predicts a label related to the priority (step S204).

The determination device 20 can notify an analyst of the SOC of the IOC with high priority based on the predicted label.

[Effects of First Embodiment] As described above, the feature information extraction unit 21 acquires the observation result of the predetermined organization for the IOC included in the information related to the cyber security. The feature information extraction unit 21 creates the feature information of the IOC based on information obtained from the observation result acquired by the feature information extraction unit 21.

Thus, the feature information useful for determining the priority of the IOC investigation can be obtained.

The feature information extraction unit 21 acquires a detection status of an item related to the IOC by a threat intelligence service. The feature information extraction unit 21 creates feature information based on the detection status.

Thus, the feature information extraction unit 21 can reflect in the feature information whether the IOC is malignant or benign, or the degree of threat of the IOC.

The feature information extraction unit 21 acquires a DNS record corresponding to a domain name associated with the IOC as an observation result. The feature information extraction unit 21 creates feature information based on the number of changes of the information of the DNS record.

Thus, the feature information extraction unit 21 can distinguish a domain name in which the DNS record itself is frequently changed from a domain name in which the DNS record itself is stably used.

The feature information extraction unit 21 acquires a DNS record corresponding to a domain name associated with the IOC as an observation result. The feature information extraction unit 21 creates feature information based on the number of times of use and the period of use of the DNS record.

Thus, the feature information extraction unit 21 can reflect the DNS trend related to the domain name on the feature information.

The feature information extraction unit 21 creates feature information based on information obtained from the observation result and a statistic calculated from the information.

Thus, the feature information extraction unit 21 can obtain more feature information from limited information.

[System Configuration and the like] Further, each component of each illustrated device is a functional conceptual component and does not necessarily need to be physically configured as illustrated in the drawings. That is, a specific form of distribution and integration of the respective devices is not limited to the form illustrated in the drawings, and all or some of the devices can be distributed or integrated functionally or physically in any units according to various loads, and use situations. Further, all or some of processing functions to be performed in each device can be realized by a CPU and a program analyzed and executed by the CPU, or can be realized as hardware using a wired logic. The program may be executed not only by the CPU but also by another processor such as a GPU.

Further, all or some of the processing described as being performed automatically among the processing described in the present embodiment can be performed manually, and alternatively, all or some of the processing described as being performed manually can be performed automatically using a known method. In addition, information including the processing procedures, control procedures, specific names, and various types of data or parameters illustrated in the above literature or drawings can be arbitrarily changed unless otherwise described.

[Program] As an embodiment, the determination device 20 can be implemented by installing a determination program for executing the determination processing in a desired computer as packaged software or on-line software. For example, it is possible to cause an information processing device to function as the determination device 20 by causing the information processing device to execute the detection program. Here, the information processing device includes a desktop or laptop personal computer. Further, a mobile communication terminal such as a smart phone, a mobile phone, or a personal handyphone system (PHS), or a slate terminal such as a personal digital assistant (PDA), for example, is included in a category of the information processing device.

The determination device 20 can be implemented as a determination server device which provides a service related to the determination processing to a client which is a terminal device used by a user. For example, the determination server device is implemented as a server device that provides a determination service that inputs security alerts and outputs high-priority IOCs. In this case, the determination server device may be implemented as a Web server or as a cloud that provides services related to the determination processing described above by outsourcing.

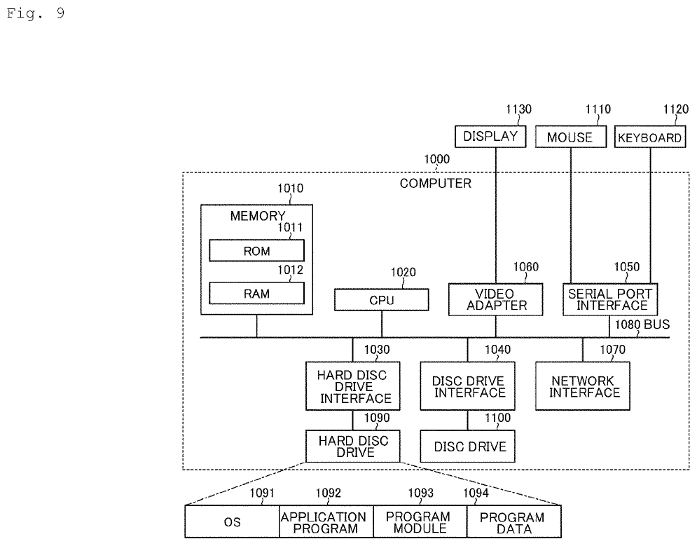

FIG. 9 is a diagram illustrating an example of a computer that executes a determination program. A computer 1000 includes, e.g., a memory 1010 and a CPU 1020. Further, the computer 1000 also includes a hard disk drive interface 1030, a disk drive interface 1040, a serial port interface 1050, a video adapter 1060, and a network interface 1070. These units are connected to one another via a bus 1080.

The memory 1010 includes a Read Only Memory (ROM) 1011 and a Random Access Memory (RAM) 1012. The ROM 1011 stores, for example, a boot program such as a Basic Input Output System (BIOS). The hard disk drive interface 1030 is connected to the hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each processing of the determination device 20 is implemented as the program module 1093 in which a code that can be executed by the computer has been described. The program module 1093 is stored in, for example, the hard disk drive 1090. For example, the program module 1093 for executing the same processing as a functional configuration in the determination device 20 is stored in the hard disk drive 1090. The hard disk drive 1090 may be replaced with a solid state drive (SSD).

Further, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the above-described embodiment.

The program module 1093 and program data 1094 are not limited to being stored in the hard disk drive 1090 and may also be stored in, for example, a removable storage medium to be read out by the CPU 1020 via the disk drive 1100 or the like. Alternatively, the program module 1093 and the program data 1094 may be stored in another computer connected via a network (a Local Area Network (LAN), a Wide Area Network (WAN), or the like). In addition, the program module 1093 and the program data 1094 may be read by the CPU 1020 from the other computer via the network interface 1070.

### REFERENCE SIGNS LIST

1 Security system
10 Analysis engine
20 Determination device
21 Feature information extraction unit
22 Labeling unit
23 Learning unit
24 Prediction unit
25 Model information
30 Alert monitor
40 IOC checker

1. An extraction method executed by an extraction device, the extraction method comprising:
acquiring an observation result by a predetermined organization with respect to an indicator of compromise (IOC) included in information on cyber security; and
creating feature information of the IOC based on information obtained from the observation result acquired.

2. The extraction method according to claim 1, wherein a detection status of an IOC-related matter by a threat intelligence service is acquired, and
the feature information is created based on the detection status.

3. The extraction method according to claim 1, wherein a domain name system (DNS) record corresponding to a domain name associated with the IOC is acquired as the observation result, and
the feature information is created based on a number of changes in the information of the DNS record.

4. The extraction method according to claim 1, wherein a domain name system (DNS) record corresponding to a domain name associated with the IOC is acquired as the observation result, and
the feature information is created based on a number of times of use and a period of use of the DNS record.

5. The extraction method according to claim 1, wherein the feature information is created based on information obtained from the observation result and a statistic calculated from the information.

6. An extraction device comprising:
processing circuitry configured to:
acquire an observation result by a predetermined organization with respect to an indicator of compromise (IOC) included in information on cyber security; and
create feature information of the IOC based on information obtained from the observation result acquired.

7. A non-transitory computer-readable recording medium storing therein an extraction program that causes a computer to execute a process comprising:
acquiring an observation result by a predetermined organization with respect to an indicator of compromise (IOC) included in information on cyber security; and
creating feature information of the IOC based on information obtained from the observation result acquired.
